(19) United States
(12) Patent Application Publication
(10) Pub. No.: US 2018/0336563 A1
(43) Pub. Date: Nov. 22, 2018

(54) ELECTRONIC PAYMENT CARD SYSTEMS AND METHODS WITH ROGUE AUTHORIZATION CHARGE IDENTIFICATION AND RESOLUTION

(71) Applicant: MasterCard International Incorporated, Purchase, NY (US)

(72) Inventors: Marthom Daetz, St. Louis, MO (US); Andrea Catalina Berdugo, Dublin (IE)

(21) Appl. No.: 15/597,828

(22) Filed: May 17, 2017

(51) Int. Cl. G06Q 20/40; G06Q 20/10

(52) U.S. Cl. CPC G06Q 20/4014; G06Q 20/10

(57) ABSTRACT

An electronic payment card system and method includes at least one computing device communicating in an interchange network to process payment-by-card transactions. The computing device is configured to accept an identified possible rogue authorization charge stemming for an advance authorization charge requested on the payment system and having a pending status in the payment system. The system and method investigates the identified charges, eliminates adverse effects of the identified possible rogue authorization charge, and resolves inaccurate available credit balances on cardholder accounts attributable to rogue authorization charges.

### BACKGROUND

This disclosure relates generally to electronic payment systems for payment-by-card transactions, and more specifically to electronic payment card systems and methods for electronically resolving available credit balance errors for transactions involving advance payment authorizations.

Electronic payment card systems are in widespread use to process transactions between a payment card holder, a merchant, an acquirer bank, and an issuing bank. The transaction may involve the physical payment card itself at a point-of-sale terminal, a device associated with a payment card (or an account of a payment card) that includes payment card information and digital payment capability (e.g., a smart phone device including a digital wallet), or manually entered payment card information via another device such as a computer device interfacing with a merchant online. Sophisticated multi-party payment card systems are known to process payment card transactions, confirm authorized charges, manage payments and transfer of funds, confirm payment status, and compute available credit balances. Cardholders may easily retrieve information online to check their account charge balances and available credit balances whenever desired.

For technical reasons relating to how a particular purchase transaction was transacted, the account balances and available credit balances according to the payment system are sometimes incorrect. Specifically, transactions involving a temporary advance payment authorization can lead to a temporary miscalculation of account balance on the system that in some cases can be consequential to the operation of the system to process further payment-by-card transactions for certain cardholders. Improvements are accordingly desired.

### BRIEF DESCRIPTION

In one aspect, the disclosure provides an electronic payment card system including at least one host computing device having at least one processor in communication with a memory device and a payment network for processing payment-by-card transactions. The at least one host computing device is configured to: receive an identified possible rogue authorization charge in at least one cardholder account; and in response to the receiving the identified possible rogue authorization charge, automatically issue a temporary credit through the payment network to the at least one cardholder account in the amount of the received identified possible rogue authorization charge.

In another aspect, the disclosure provides a method for correcting rogue authorization charges in an electronic payment card system. The method is implemented with at least one host computing device including at least one processor in communication with a memory device and a payment network for processing process payment-by-card transactions. The method includes: receiving an identified possible rogue authorization charge in at least one cardholder account; and in response to the accepted identified possible rogue authorization charge, automatically issuing a temporary credit though the payment network to the at least one cardholder account in the amount of the received identified possible rogue authorization charge.

### BRIEF DESCRIPTION OF THE DRAWINGS

FIG. 1 illustrates an example embodiment of an exemplary payment card system including rogue authorization charge identification and resolution components.

FIG. 2 is a simplified block diagram of a portion of the payment card system shown in FIG. 1.

FIG. 3 illustrates an example configuration of a user device for the system shown in FIGS. 1 and 2.

FIG. 4 illustrates an example configuration of a server system as described herein.

FIG. 5 shows an example configuration of a user account database within a computing device, along with other related computing components, that may be used to create, organize, and monitor a plurality of user data associated with a user.

FIG. 6 shows an exemplary process of rogue authorization charge identification for the system shown in FIGS. 1-5.

FIG. 7 shows an exemplary process of rogue authorization charge resolution for the system shown in FIGS. 1-5.

FIG. 8 illustrates a first exemplary display screen for the system shown in FIGS. 1-5

FIG. 9 illustrates a second exemplary display screen for the system shown in FIGS. 1-5.

FIG. 10 illustrates a third exemplary display screen for the system shown in FIGS. 1-5.

FIG. 11 illustrates an exemplary method flowchart of processes executed by the system shown in FIGS. 1-5.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The system and methods described herein are configured to address certain problems and challenges in processing payment-by-card transactions including an advance authorization charge in a set amount, when the actual purchase amount is uncertain or unknown until sometime later. Such problems and challenges are further discussed below followed by exemplary systems and methods that overcome such problems and challenges.

As conventionally implemented, a multi-party payment card processing system enables payment-by-card transactions with a payment card system such as a credit card payment system using the Mastercard® payment card system payment network (also referred to as an “interchange” or “interchange network”). The Mastercard® payment card system payment network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

In a typical transaction card system, a financial institution called the “issuer” issues a transaction card, such as a credit card, to a consumer or a cardholder, who uses the transaction card to tender payment for a purchase from a merchant. To accept payment with the transaction card, a merchant must normally establish an account with a financial institution that is part of the financial payment system. This financial institution is usually called the “merchant bank,” the “acquiring bank,” or the “acquirer.” When the cardholder tenders payment for a purchase with a transaction card, the merchant requests an authorization from an acquirer for the amount of the purchase. The request may be performed over the telephone, but is usually performed through the use of a point-of-sale terminal, which reads a cardholder's account information from a magnetic stripe, a chip, or embossed characters on the transaction card and communicates electronically with the transaction processing computers of the acquirer. Alternatively, the acquirer (also referred to as merchant bank) may authorize a third party to perform transaction processing on its behalf. In this case, the point-of-sale terminal is configured to communicate with the third party. Such a third party is usually called a “merchant processor,” an “acquiring processor,” or a “third party processor.”

Using an interchange network, computers of the acquirer or the merchant processor communicate with computers of an issuer to determine whether a cardholder's account is in good standing and whether the purchase is covered by the cardholder's available credit line. Based on these determinations, the request for authorization is declined or accepted. If the request is accepted, an authorization code is issued, or an authorization response message is provided, to the merchant. More specifically, an ISO 8583 compliant message or an ISO 20022 compliant message may be issued or communicated.

When a request for authorization is accepted, the available credit line of cardholder's account is decreased by the amount requested. Normally, a charge for a payment card transaction is not posted immediately to a cardholder's account because bankcard associations, such as Mastercard International Incorporated®, have promulgated rules that do not allow a merchant to charge, or “capture,” a transaction until goods are shipped or services are delivered. However, with respect to at least some debit card transactions, a charge may be posted at the time of the transaction. When the merchant ships or delivers the goods or services, the merchant captures the transaction by, for example, appropriate data entry procedures on the point-of-sale terminal. This may include bundling of approved transactions daily for standard retail purchases. If the cardholder cancels a transaction before it is captured, a “void” is generated. If the cardholder returns goods after the transaction has been captured, a “credit” is generated. The interchange network and/or the issuer stores the transaction card information, such as a type of merchant, amount of purchase, date of purchase, in a data warehouse (not shown).

After a purchase has been made, a clearing process occurs to transfer additional transaction data related to the purchase among the parties to the transaction, such as the acquirer, the interchange network, and the issuer. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

As used herein, the term “transaction data” refers to data that includes at least a portion of a cardholder's account information (e.g., cardholder name, account identifier, credit line, security code, and/or expiration data) and at least a portion of purchase information (e.g., price, a type of item and/or service, SKU number, item/service description, purchase date, and/or confirmation number) supplied by a merchant from which the cardholder is making a purchase.

After a transaction is authorized and cleared, the transaction is settled among merchant, acquirer, and issuer. Settlement refers to the transfer of financial data or funds among cardholder's account, acquirer, and issuer related to the transaction. Usually, transactions are captured and accumulated into a “batch,” which is settled as a group.

For various reasons, merchants sometime request an advance authorization charge from a payment card system in a certain amount at a first point in time pending an actual completion of a transaction that is likely to be completed with a final charge in a different amount at a second point in time subsequent to the first point in time. Such advance authorizations typically relate to payment card transactions involving some contingency and uncertainty in the actual final purchase price that will not resolved until the second point in time. Such issues may arise, for example, when a quantity of goods or services that will actually be purchased is not fully known in advance, including the exemplary hotel charge scenarios described below. Advance authorizations are included in other types of transactions such as but not included to the purchase of gasoline with a payment card. The exemplary hotel charge scenarios described below are therefore for the sake of illustration rather than limitation. Regardless of how it originates, the advance authorization charge appears on the cardholder account as a “pending” charge on the payment card system and assures a possible payment to the merchant in the amount requested, which may be higher or lower than the actual charge at the end of the transaction.

While the advance authorization charge could perhaps be accepted by the merchant, a second transaction would need to be run through the system to capture the difference in amount as either a credit or a charge in order to obtain payment for the final amount. Instead of doing this, merchants are known to simply run another request through the payment card system for authorization to charge the entire actual amount of the final transaction. If approved, no action is taken with respect to the advance authorization charge. Consequently, the advance authorization charge may remain as a pending transaction on a cardholder's account for some time after the related transaction has been fully completed. Such residual advance authorization charges are referred to herein as “rogue authorizations” because they no longer serve a legitimate purpose on the system. Such rogue authorization charges are not in any way fraudulent, but nonetheless are problematic from both a cardholder's perspective and entities associated with the payment card system. While rogue authorization charges usually fall off a cardholder's account in the clearing process without ever resulting in an actual charge to the account, it can take as long as 30 days for this to happen in conventional payment card systems. Depending on the amount of the advance authorization charges, this can have a ripple effect on the operation of the payment system to correctly process subsequent transactions and/or to correctly report available credit balances for affected cardholders.

For example, certain hotels or resorts may run a traveler's payment card through a card payment system at check-in. The hotel/resort then receives an authorization to charge a certain amount to the payment card at check-in time. The actual fee for the traveler's stay, however, will be the sum of fixed charges (i.e., the daily/nightly fee for the hotel/resort accommodations multiplied by the number of days/nights of the stay) plus any add-on charges incurred via choices yet to made by the traveler during the stay. Add-on charges may include items such as snacks or drinks consumed from a snack bar in the room, charges for movies and entertainment available to guests, room service charges or other charges made to the traveler's room in on-site restaurants and shops, charges for on-site laundry services, activity fees for on-site or off-site attractions or excursions, or rental fees for desired items or equipment made available to travelers. At the time of check-out, the add-on charges are now known and the actual fee, in this case the sum of the fixed nightly room charges plus the add-on charges and taxes, can be computed in the proper amount.

As the proper fee at check-out and the prior authorization charge at check-in are usually not the same, the hotel/resort typically may again run the traveler's payment card again through the card payment system in the proper amount at check-out time. The check-out transaction may be authorized and cleared as described above. In some instances, however, even though the check-out transaction is fully completed, the advance authorization from check-in still remains in place on the system as a “pending” charge on the system. At this time, the advance charge authorization is now a “rogue” authorization that no longer serves a legitimate purpose in the system, but is nonetheless deemed a “pending” charge in the payment system. The rouge authorization charge continues to lower the available balance by the corresponding amount, and while it is eventually cleared without actual charges being made it can take a complete billing cycle, or about 30 days, for this to actually happen. Of course, both the advance authorization at check-in and the proper charge at check-out can be substantial in amount depending on the length of stay and particulars of the hotel/resort. Undesirably, the advance authorization charge at check-in and the proper charge at check-out cumulatively lower the available credit balance on the card until the advance authorization falls off the account.

Cardholders that access their account information online are apt to notice rogue authorization charges when present, and are likely to have an unfavorable impression of them. As mentioned above, the rogue charges are not fraudulent but may appear to be at first impression and therefore may be suspicious and alarming to many cardholders. In small amounts, rogue authorization charges may simply be a nuisance, while in larger amounts they may actually interfere with further payment card transactions in the payment system. In particular, additional payment card transactions may be denied because of existing rogue authorizations that reduce available credit balances to insufficient levels to complete the additional transactions. If the payment system declines the additional transactions in such a scenario the traveler may rightfully be surprised and upset.

Relations between card issuers and cardholders may rapidly deteriorate if they cannot quickly resolve rogue charges to a customer's satisfaction, but unfortunately this is often not possible in conventional payment card systems. At present, a cardholder has little resort other than to place a call to a number provided on the payment card for assistance, but the person taking the call may or may not recognize the possibility of a rogue authorization charge scenario and not be considered helpful by the cardholder. Even if rogue authorization charges may be suspected, an attempt to explain them may fall short, and the person taking the call may lack any ability to confirm or verify whether any charges actually are rogue authorizations. Regardless, the person taking the call from the cardholder likely will lack an ability to quickly correct rogue charges to the cardholder's satisfaction.

Because of the limitations above, the call from the cardholder typically commences an investigation of any suspected rogue charge(s). Such investigations may eventually resolve the rogue charges in the cardholder's favor, but the investigation takes some time to complete as it entails some communication between representatives of the merchant and/or a financial institution in the payment network to resolve. Human misunderstanding or error in conducting the investigation is also possible, leading to delays in effectively resolving rogue charges. Meanwhile, until the investigation is resolved, the rouge authorization charges will continue to be a limiting factor in use and enjoyment of the card to make other desired payment-by-card transactions. In the case of a traveling cardholder unable to complete necessary transactions, or otherwise a cardholder seeking to purchase an essential item, denials of charges in the payment system that are attributable to rogue authorization charges may impose undue hardship.

In view of the above, existing payment card systems and methods have yet to completely meet the needs of the marketplace in the aspects described and improvements are desired. Cardholders and payment system representatives would each benefit from ill effects caused by rogue authorization charges.

The methods and systems described below overcome the difficulties described above and beneficially allow cardholders and/or parties to the payment system to proactively identify and resolve rogue authorization charges, to minimize the consequences of rogue authorization charges to the cardholder and to the payment system once identified, to improve the payment card experience for the cardholder by allowing continued full use and enjoyment of the payment card pending investigation of rogue charges, and to alleviate the cost and burdens of payment system representatives to personally respond to possible rogue authorization charges. In the systems and methods disclosed herein, declines of additional charges in the payment system that could otherwise occur because of the rogue authorization are entirely precluded, and available balances may quickly be restored and communicated to cardholders in more or less real-time as possible rogue charges are identified.

More specifically, the systems and methods described below include a plurality of computing devices communicating with one another, and at least some of the devices communicating in an interchange network (e.g., a payment network) to process payment-by-card transactions. Possible rogue authorization charges can be identified either manually by a system user or in an automated manner via one or more of the computing devices, and accepted by one of the computing devices without requiring a conversation between a cardholder and a payment card representative. The identification of possible rogue authorization charges may be made quickly and conveniently with a computer device, and once accepted the system may automate an investigation process thereafter. Investigations and resolutions of possible rogue authorization charges may be completed more efficiently and in a dramatically reduced amount of time with one or more of the computing devices.

In the payment card systems and methods of the disclosure, once possible rogue charges are identified and accepted on a particular card account, a temporary credit is issued to the card account by one of the computing devices to negate the possible rogue charges pending confirmation of the charges as actual rogue charges. As such, the possible rogue charges no longer impact the available balance on the payment card and the payment card system operates to process additional transactions as if the rogue charges did not exist.

If and when the possible rogue charges are confirmed as actual rogue charges, which may be accomplished by comparing the transaction data of a possible rogue authorization charge with previous transaction data involving the same merchant, then both the temporary credit and the rogue charge are removed from the card account. On the other hand, if the possible rogue charges cannot be confirmed as actual rogue charges, the temporary credit is removed, the charges identified as rogue remain, and the available balance for the payment card reverts to again reflect the charges identified as possible rogue charges. The system may archive and log instances of possible rogue charge identifications, confirmations of actual rogue charges, and other transaction data to address abusive use of the system by certain users or attempts to manipulate or exploit the credits issued by the system via false identification of possible rogue charges.

Screen displays may be generated in the system and methods of the disclosure allowing a user to review pending charges and identify them as possible rogue charges in relation to other charges that have been recently cleared and are no longer pending charges. Screen displays may also be generated showing a corrected available account balance in view of possible rogue charges and temporary credits issued. Screen displays may be generated showing the status of possible rogue charges as confirmed or not confirmed for review by the cardholder. Feedback and information concerning rogue charges may be displayed in real time to any interested party.

Alerts and notifications may be generated and sent to cardholders, as well as a financial institution associated with the payment network such as the card issuer, concerning possible rogue charges identified in the system. The alerts may be configured to activate a cardholder device or issuer device and present information concerning possible rogue charges on a display of the cardholder or issuer device for review by the cardholder or issuer. The display may include an option for the user (i.e., the cardholder or issuer) to confirm that such charges are to be disputed such that the system can take further action to investigate and reconcile such disputed charges. Alternatively, the alerts may be accessed by the cardholder or issuer via dashboard after logging into the system with a computing device, and the cardholder or issuer may be presented information regarding possible rogue authorization charges on a display of the computing device, including an option for the user to confirm that such charges are to be disputed such that the system can take further action to investigate and reconcile such disputed charges.

In one embodiment, the disclosure provides an electronic payment card system including at least one host computing device having at least one processor in communication with a memory device and a payment network for processing payment-by-card transactions. The at least one host computing device is configured to: receive an identified possible rogue authorization charge in at least one cardholder account; and in response to the receiving the identified possible rogue authorization charge, automatically issue a temporary credit through the payment network to the at least one cardholder account in the amount of the received identified possible rogue authorization charge.

The received identified possible rogue authorization charge may be communicated from a cardholder computing device to the at least one host computing device via a cardholder portal. The at least one host computing device may be a financial institution computing device, and the financial institution computing device may be a card issuer device.

The at least one host computing device may further be configured to confirm whether or not the received identified possible rogue authorization charge is actually a rouge authorization charge. The at least one host computing device may be configured to: electronically compare transaction data of the received identified possible rogue authorization charge to transaction data of another recently cleared transaction involving the same merchant; and if the compared transaction data matches, confirm the accepted identified rogue authorization charge as actually a rouge authorization charge.

In the system, if the accepted identified possible rogue authorization charge is confirmed to actually be a rouge authorization charge, the at least one computing device may further be configured to automatically remove the temporary credit and the rogue authorization charge from the at least one cardholder account.

The system may include a computing device generating at least one screen display allowing a user to identify a possible rogue authorization charge to the at least one computing device, at least one screen display allowing a user to identify a cleared charge for evaluating the identified possible rouge authorization charge, or at least one screen display including a corrected available balance for a confirmed rogue authorization charge.

The at least one host computing device may be a server system. The at least one host computing device may also be configured to: identify at least one possible rogue authorization charge posted to the at least one cardholder account; notify the cardholder of the possible rogue authorization charge; and in response to the notification, allow the cardholder to dispute the possible rogue authorization charge.

The at least one host computing device may also be configured to: automatically identify at least one possible rogue authorization charge posted to the at least one cardholder account; alert a card issuer of the possible rogue authorization charge; and in response to the alert, allow the card issuer to correct the possible rogue authorization charge before any action needs to be taken by the cardholder.

In another embodiment, the disclosure provides a method for correcting rogue authorization charges in an electronic payment card system. The method is implemented with at least one host computing device including at least one processor in communication with a memory device and a payment network for processing process payment-by-card transactions. The method includes: receiving an identified possible rogue authorization charge in at least one cardholder account; and in response to the accepted identified possible rogue authorization charge, automatically issuing a temporary credit though the payment network to the at least one cardholder account in the amount of the received identified possible rogue authorization charge.

Receiving the identified possible rogue authorization charge may include accepting the identified possible authorization charge from a cardholder computing device via a cardholder portal. Automatically issuing a temporary credit to the at least one cardholder account in the amount of the accepted identified possible rogue authorization charge may include automatically issuing the temporary credit from a financial institution computing device communicating in the interchange network.

Issuing the temporary credit from a financial institution computing device communicating in the interchange network may include issuing the temporary credit from a card issuer device. The method may also include electronically confirming whether or not the accepted identified possible rogue authorization charge is actually a rouge authorization charge. Electronically confirming whether or not the accepted identified possible rogue authorization charge is actually a rouge authorization charge may include: comparing transaction data of the accepted identified possible rogue authorization charge to transaction data of another recently cleared transaction involving the same merchant; and if the compared transaction data matches, confirming the accepted identified rogue authorization charge as actually a rouge authorization charge.

The method may further include, if the accepted identified possible rogue authorization charge is confirmed to actually be a rouge authorization charge, automatically removing the temporary credit and the rogue authorization charge from the at least one cardholder account. The method may also include generating at least one screen display allowing a user to identify the possible rogue authorization charge, generating at least one screen display allowing a user to identify a cleared charge for evaluating the identified possible rouge authorization charge, or generating at least one screen display including a corrected available balance for a confirmed rogue authorization charge.

Receiving an identified possible rogue authorization charge in at least one cardholder account may include accepting an identified possible rogue authorization charge with a server system. The method may also include: automatically identifying at least one possible rogue authorization charge posted to the at least one cardholder account; notifying the cardholder of the possible rogue authorization charge; and in response to the notification, allowing the cardholder to dispute the possible rogue authorization charge. The method of claim may alternatively include: automatically identifying at least one possible rogue authorization charge posted to the at least one cardholder account; alerting a card issuer of the possible rogue authorization charge; and in response to the notification, alerting the card issuer to correct the possible rogue authorization charge before any action needs to be taken by the cardholder.

The technical problems addressed by the payment card systems and methods of the disclosure include at least one of: (i) inability to detect inaccuracies in available balances of payment cards as determined by a payment card system; (ii) inability to identify charges that account for inaccurate available balances of payment cards; (iii) inability to efficiently and accurately complete transaction payment processing involving advance charge authorizations; (iv) inability to efficiently resolve disputed charges related to transactions involving advance charge authorizations; (v) inability to prevent denial of payment card transactions because of inaccurate credit balances; (vi) inability to quickly restore available balances to the proper amount to avoid hardship to a cardholder; (vii) inability to investigate disputed charges without personal interaction between a cardholder and a representative of the payment network; and (viii) inability to avoid human error in payment card transactions.

The payment card systems and methods of the disclosure may be implemented using computer programming or engineering techniques including computer software, firmware, hardware, or any combination or subset thereof, wherein the technical effects may be achieved by (i) accepting a possible rogue charge identified to the system for automated resolution thereof; (ii) automatically issuing a temporary credit to zero out possible rogue charges once identified; (iii) automatically comparing transaction data to verify charges as rogue authorizations or not; (iv) applying the credits issued via the interchange network; (v) removing the credits issued and confirmed rogue charges via the interchange network; (vi) displaying a corrected account balance to a user once possible rogue charges are identified; and (vii) generating screen displays to show status of identified rogue charges as confirmed or not.

The resulting technical benefits achieved by the payment card systems and methods include at least one of: (i) providing an automated feature to dispute possible rogue charges; (ii) confirming in an automated manner whether or not possible rogue charges are actually rogue charges in a dramatically reduced timeframe; (iii) automatically negating undesirable impacts of rouge charges on available credit balances while possible rogue charges are being evaluated; (iv) preventing unwarranted denials of future card payment transactions in the payment system because of rogue charges; (v) improving the cardholder's experience in managing a cardholder account via interactive screen displays with rogue authorization identification and status features; (vi) alleviating burdens to payment card representatives in responding to calls regarding rogue charges without effective tools to resolve them; (vii) eliminate human error in identifying and resolving rogue charges; and (viii) facilitate error reporting and correction of available credit balances as determined by the system.

In one embodiment, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, any type of virtual card (e.g. virtual cards generated by issuers and/or third party processors via mobile bank or desktop apps) and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

Embodiments described herein may relate to a transaction card system, such as a credit or debit card payment system using the Mastercard® or Visa® payment network. The Mastercard® payment network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.). Embodiments described herein may also relate to digital payment services such as digital payment services such as Masterpass by Mastercard.

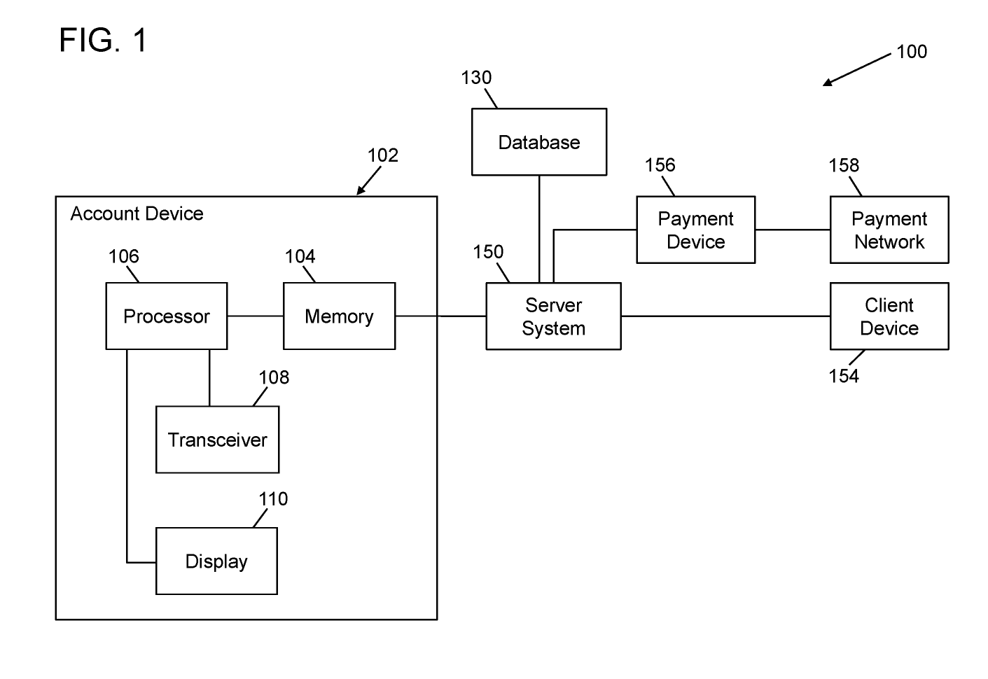

FIG. 1 illustrates an example embodiment of payment card system 100 that is configured to provide rogue authorization charge identification and resolution capability to overcome the technical problems described above, and confer the substantial technical effects and technical benefits disclosed herein. The system 100 as shown includes a cardholder account device 102 that in the example shown includes a memory 104, a processor 106, a transceiver 108, and a display 110.

The system 100 may also include a server system 150 that may communicate with the cardholder account device 102 as well as a client device 154, an optional payment device 156, a payment network 158, and a database 160 as described further below. The server system 150 may communicate with, request, accept and retrieve data and information from each of the devices 102, 152, 154, 156, 158 and the database 160 as explained below. The server system 150 is sometimes referred to herein as a “host” device that includes the rogue authorization components described further below, although it is not strictly necessary in all embodiments that the host device is a server system.

In contemplated examples, the cardholder account device 102 is connected directly or indirectly to the server system 150 via wired or wireless communication techniques and protocols. In one contemplated example, the cardholder account device 102 is used by the cardholder to access payment card account information from the server system 150, and via the display 110 the cardholder may view charge history to see cleared charges, pending charges, available credit balance information or other data of interest. Specifically with respect to the systems and methods of the invention, the display 110 may allow the user to spot possible rogue authorization charges amongst other pending charges as described in the examples below and identify them for further review and resolution in the system 100. The cardholder account device 102 may be, but is not necessarily limited to, a computer workstation, a personal computer, a laptop or notebook computer, a tablet device or a smartphone.

The client device 154 in contemplated embodiments may be used for authorized cardholder enrollment (and authorized user enrollment) by card issuers, payment network personnel, or system administrators. In contemplated embodiments the client device 154 may be utilized to, for example, enroll participating merchants and communicate merchant information to the other devices in the system 100, retrieve data from one or more of the system devices to assess its performance, troubleshoot the system, perform system updates, etc. The client device 154 may be, but is not necessarily limited to, a computer workstation, a personal computer, a laptop or notebook computer, a tablet device or a smartphone.

The payment device 156 accepts payment card transaction requests and performs payment processing for payment-by-card transactions as described above. The payment system 156 communicates with a payment network 158, which may be an interchange network described above, to process and approve the request for payment in the applicable amount. While a separate payment device 156 is shown in FIG. 1, another device in the system may alternatively communicate with the payment network 158 without first passing through a dedicated payment device 156. Multiple payment devices 156 may be in the network 100 and be utilized by different financial institutions, including but not necessarily limited to the issuer, acquirer, or third party processor in a multi-party payment system.

In a variety of contemplated examples, different combinations of devices, being the same or different from one another, may be utilized in the system 100 with otherwise similar effect. One or more of the devices 102, 152, 154 and 156 shown in FIG. 1 may be a mobile device, such as any mobile device capable of interconnecting to the Internet including a smart phone, personal digital assistant (PDA), a tablet, or other web-based connectable equipment. Alternatively, one or more of the devices 102, 152, 154 and 156 may be a desktop computer or a laptop computer. Each of the devices 102, 152, 154 and 156 may be associated with a different user as described. Each device 102, 152, 154 and 156 may be interconnected to the Internet through a variety of interfaces including a network, such as a local area network (LAN) or a wide area network (WAN), dial-in connections, cable modems and special high-speed ISDN lines.

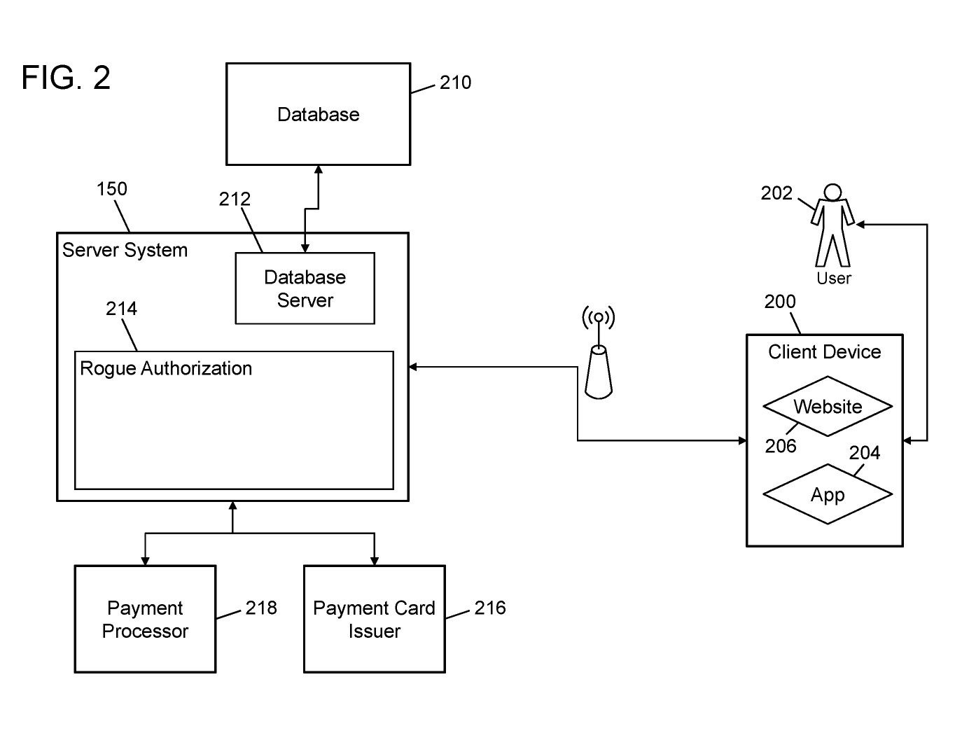

FIG. 2 is a simplified block diagram of a portion of the rogue authorization system and method 100 that includes server system 150. Server system 150 includes a rogue authorization component 214 for responding to possible rogue authorization charges pending in a particular cardholder account. Rogue authorization component 214 is in communication with at least one device 200 that may represent the respective devices 102, 154 and 156 described above. The device 200 shown may be associated with a user 202, and the user 202 may represent one of the users of the various devices 102, 154 and 156 described above.

For instance, when the device 200 is the cardholder account device 102 the user 202 is the cardholder. When the device 200 is the client device 154 the user 202 may be a system administrator. When the device 200 is the payment device 156, the user 202 may be an agent of the payment provider.

In some embodiments, the device 200 includes a software application 204 (i.e., a service app) installed on the device 200. In additional embodiments, the device 200 displays a customized website 206 using a web browser installed on the device 200. Such app or website may facilitate identification, acceptance or resolution of rogue authorization charges as well as status information for possible rogue charges.

In the example embodiment, server system 150 is in communication with a payment processor 218 and/or a payment card issuer 216. Payment processor 218 and/or server system 150 may be associated with an interchange network (not shown). Server system 150 is configured to receive transaction data from payment processor 218.

Server system 150 includes a database server 212 connected to a database 210, which contains information transaction data for enrolled cardholders. In one embodiment, database 210 is centralized and stored on server system 150. In an alternative embodiment, database 210 is stored remotely from server system 150 and may be non-centralized. Database 210 may store transaction data including data relating to merchants, merchant locations, cardholders and identified rogue charges and confirmations as described below. Specifically with respect to the system 100, the database 210 may include a plurality of files of information for enrolled cardholders, as well as recorded data regarding identified rogue charges relating to each cardholder and data regarding rogue charges associated with particular merchants.

In the example embodiment, server system 150 is configured to receive transaction data from payment processor 218. Authorizations for payment-by-card transactions may be made or denied according to conventional practices, except for the rogue authorization charge aspects implemented by the systems and method of the invention. Specifically, advance charge authorizations may be made and accepted through the system 150 by particular merchants, and as described above, such advance charge authorizations are typically held as “pending” charges for some period of time pending actual completion of the transaction. After completion of a transaction when such advance authorization charges become rogue authorizations, they may be identified and/or challenged by cardholders or other parties associated with the payment system as described below.

Although only one payment card issuer 216, one payment processor 218, one user 202, and one client device 200 are illustrated, it should be understood that the vehicle registration system may include any number of payment card issuers 216, users 202, payment networks 218, and/or devices 200 in communication with server system 150.

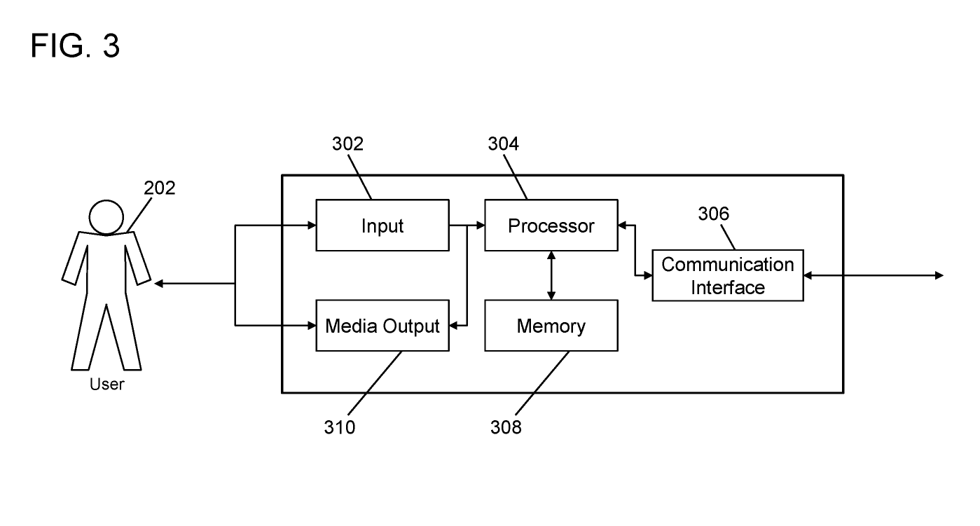

FIG. 3 illustrates an example configuration of a device 200 operated by a user 202, such as any of the users described above. User system 200 may include, but is not limited to, a smart phone, a tablet, and a website. In the example embodiment, device 200 includes a processor 304 for executing instructions. In some embodiments, executable instructions are stored in a memory area 308. Processor 304 may include one or more processing units, for example, a multi-core configuration. Memory area 308 is any device allowing information such as executable instructions and/or written works to be stored and retrieved. Memory area 308 may include one or more computer readable media.

The device 200 may also include at least one media output component 310 for presenting information to user 202. Media output component 310 is any component capable of conveying information to user 202. In some embodiments, media output component 310 includes an output adapter such as a video adapter and/or an audio adapter. An output adapter is operatively coupled to processor 304 and operatively couplable to an output device such as a display device, a liquid crystal display (LCD), organic light emitting diode (OLED) display, or “electronic ink” display, or an audio output device, a speaker or headphones.

In some embodiments, the device 200 includes an input device 302 for receiving input from user 202. Input device 302 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 310 and input device 302. The device 200 may also include a communication interface 306, which is communicatively couplable to a remote device such as the payment processor. Communication interface 306 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 308 are, for example, computer readable instructions for providing a user interface to user 202 via media output component 310 and, optionally, receiving and processing input from input device 302. A user interface may include, among other possibilities, a web browser and client application. Web browsers enable users, such as user 202, to display and interact with media and other information typically embedded on a web page or a website. An application allows user 202 to interact with a server application from a server system.

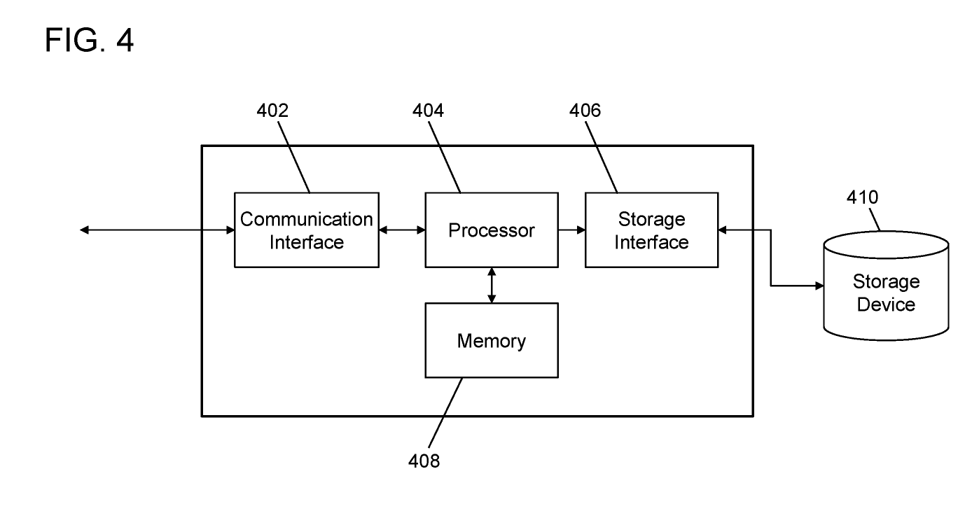

FIG. 4 illustrates an example configuration of a server system such as a server system 150 as described herein. Server system 150 is a database used and managed by at least one of a merchant and a third party, and used to store user account data, and send, receive, and process signals from various sources. Server system 150 includes a processor 404 for executing instructions. Instructions may be stored in a memory area 408, for example. Processor 404 may include one or more processing units (e.g., in a multi-core configuration) for executing instructions. The instructions may be executed within a variety of different operating systems on the server system 150, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 404 is operatively coupled to a communication interface 402 such that server system 150 is capable of communicating with a remote device such as any of the devices 200 described above or another server system 150. For example, server system 150 may be a server system, wherein communication interface 402 may receive data from payment processor 218.

Processor 404 may also be operatively coupled to a storage device 410. Storage device 410 is any computer-operated hardware suitable for storing and/or retrieving data. In some embodiments, storage device 410 is integrated in server system 150. For example, server system 150 may include one or more hard disk drives as storage device 410. In other embodiments, storage device 410 is external to server system 150 and may be accessed by a plurality of server systems 150. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 406. Storage interface 406 is any component capable of providing processor 404 with access to storage device 410. Storage interface 406 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory area 408 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

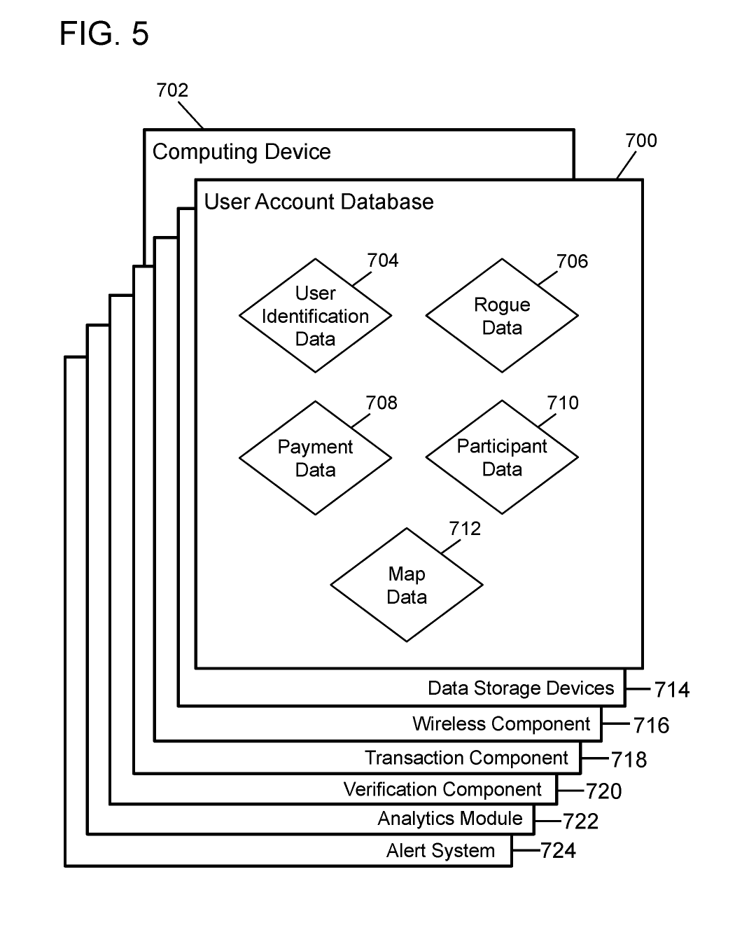

FIG. 5 shows an example configuration of a user account database 700, within a computing device 702, along with other related computing components, that may be used to create, organize, and monitor a plurality of user data associated with a user account. In some embodiments, computing device 702 is the same or similar to server system 150. User account database 700 is coupled to several separate components within computing device 702, which perform specific tasks.

In the example embodiment, database 700 includes user identification data 704, rogue authorization data 706, payment data 708, registration data 710, and participant data 712. In contemplated embodiments, user identification data 704 includes, but is not limited to, a user name, a user address, and a user phone number. Rogue authorization data 706 includes data associated with the instances of possible rogue authorization data identified in the system, data associated with success or failure of confirmations of rogue authorization data, data associated with issued credits responsive to identified possible rogue authorizations, data associated with removal of issued credits and confirmed rogue charges, cardholder data and merchant data associated with rogue charge reports and confirmation, date and time data for rogue charge reports and resolution, or other data and information of interest desired to assess the performance of the system in addressing rogue authorization issues. Payment data 708 includes, but is not limited to, card information, payment history, and a billing address. Merchant data 710 includes information associated with participating merchants, including merchant identifiers, address information, contact information, etc. Participant data 712 includes data associated with third party information (e.g., system administrators).

Computing device 702 includes the database 700, as well as data storage devices 714. Computing device 702 also includes a wireless component 716 and a transaction component 718 for correlating, for example, payment card transactions. An analytics module 722 is included for analyzing transactions, enrollment status, the rogue authorization data discussed above, time to complete transactions and other items of interest. Further included is a verification module 720 that may communicate with a payment, and an alert module 724 for transmitting an alert to a cardholder, merchant or an issuer, or to any other interested party so that possible fraudulent activity may be timely investigated and resolved.

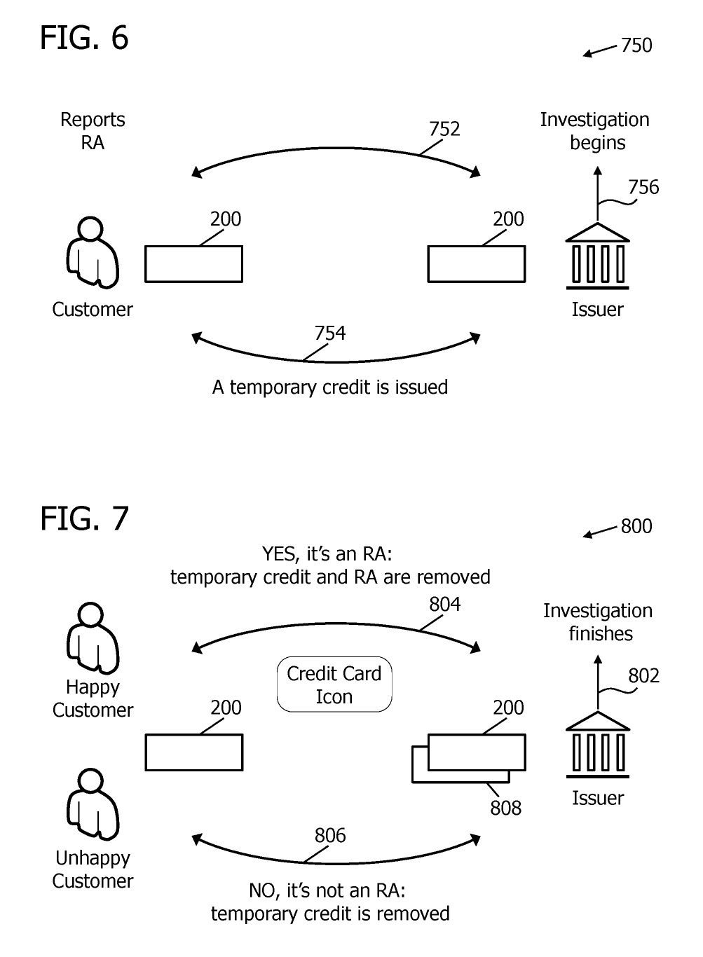

FIG. 6 shows an exemplary process 750 of rogue authorization charge identification for the system shown in FIGS. 1-5. A cardholder, using a first device 200 (also represented as the cardholder account device 102 shown in FIG. 1) identifies a suspected or possible rogue authorization charge for review by the system. Such identified charges are deemed “suspected” or “possible” as they may or may not turn out to actually be rogue authorization charges as described herein. The identified possible rogue authorization charge is accepted as indicated by arrow 752 with the device 102 and sent in the system via, for example, the server system 150 to a second device 200. The second device 200 is associated with one of the financial institutions in the payment network, such as the card issuer in the example shown in FIG. 6.

When the accepted possible rogue authorization charge indicated at 752 is received by the second device 200, the financial institution (the issuer bank in this example) issues a temporary credit back to the system as indicated by arrow 754 in the same amount of the accepted possible rogue authorization charge, while also commencing an investigation as indicated by arrow 756. The credit negates or zeros out the suspected or possible rogue authorization charge, and the investigation 756 is conducted as described further below to confirm that the suspected charges actually are rogue charges.

The temporary credit issued is posted on the system and may be seen by the cardholder using the first device 200. Once the temporary credit is made, the available credit balance is recomputed for the affected payment card and the payment card may be used as if the suspected possible rogue authorization charge did not exist. The activity represented in FIG. 6 may be completed in a very short period of time by the devices involved once the possible or suspected rogue charges are identified. As such, the system provides practically immediate assurance to the cardholder that the suspected charge(s) are being investigated and also practically immediate relief from any constraints imposed on the cardholder's ability to use the card pending completion of the investigation.

FIG. 7 shows an exemplary process of rogue authorization charge resolution for the system shown in FIGS. 1-5. As indicated at arrow 802 the investigation of the possible or suspected rogue authorization charge is now complete, and the second device 200 (of the issuer bank in this example) sends either a confirmation of an actual rogue authorization charge as indicated at arrow 804 or a rejection of the possible or suspected rogue authorization charge. The confirmation 802 or rejection 804 may be seen by the cardholder using the first device 200, and decision data for the confirmation or rejection is sent to the system as indicated by arrow 806 and may be stored, for example, by the server system 150.

As part of the confirmation 804 of rouge charges, the second device 200 (of the issuer bank in this example) removes each of the temporary credit issued and the confirmed rogue authorization charge from the cardholder's account. In this case, the available credit balance does not change as the credit was previously issued to negate it, but the rogue authorization charge no longer appears as a pending charge. The cardholder using the first device 200 can see that this has been done. As the investigation and confirmation can be quickly completed in the system, the cardholder enjoys prompt and almost effortless customer service. Instead of being upset by a suspected rogue authorization charge, the educated customer may have confidence that such issues are simply a matter of account housekeeping that is easily accomplished with the system. Suspected rogue authorization charges can be quickly and easily resolved online by the cardholder without having to place a call to a customer service representative. For educated customers, this can even be done in response to a declined transaction by the payment system, such that potential hardship attributable to rogue authorization charges can almost immediately be mitigated, if not avoided with some proactive monitoring of pending charges on their account.

As part of the rejection 806 of a suspected charge as rogue charges, the temporary credit is removed or revoked and the suspected charge remains in place. The available credit balance on the system again changes to again include the suspected charge. Any limitations on use of the card because of the suspected charge are again imposed. The cardholder may see this result using the first device 200 and know that the investigation has been completed but that the suspected charge has been deemed a proper charge that is something other than a rogue authorization charge.

The confirmations and rejections and associated data are stored at step 808 and may be analyzed to monitor system performance and to police a proper use of the rogue authorization charge features provided. For example, if a given cardholder makes an excessive number of suspect charge reports in a predetermined timeframe, or receives a number of rejections of suspect charges reported, the system may suspend further ability by that cardholder to use the rogue authorization features and receive credits. Abusive or manipulative behavior by cardholders may be closely monitored and prevented in view of data collected. Also, rogue authorization charges resulting from particular merchants that do not ordinarily request advance authorization charges may be flagged by the system for further review, and data and information can be provided to merchants or their associated acquiring banks to refine their use of requesting advance authorization charges.

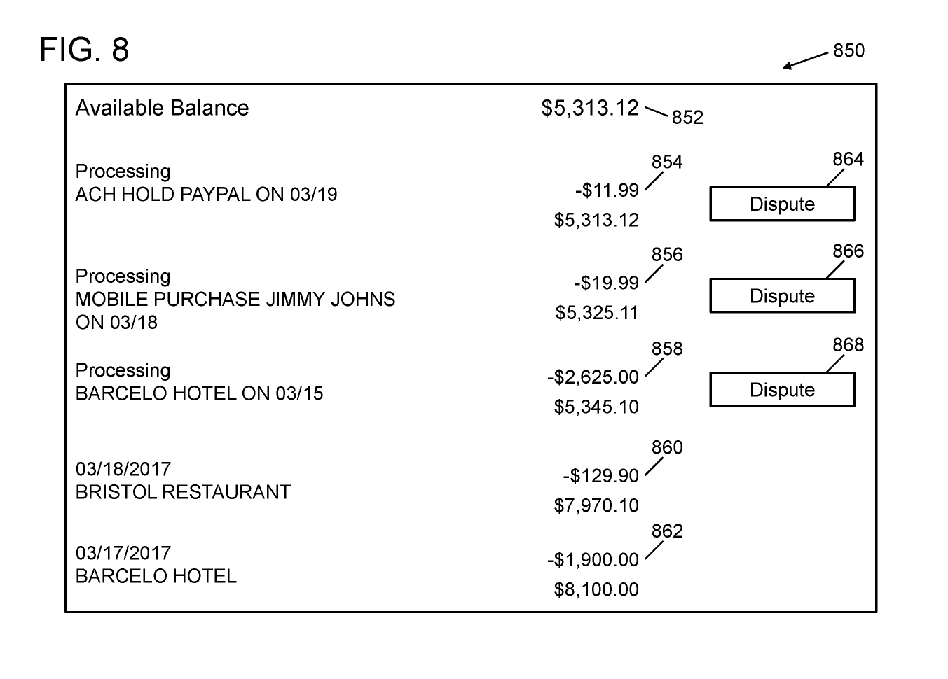

FIG. 8 illustrates a first exemplary display screen 850 for the system shown in FIGS. 1-5. When an enrolled cardholder logs onto the system using the first device 200 in the examples of FIGS. 6 and 7, the cardholder, via a customer portal, may see the display screen 850 including current account information from the payment system. The display screen 850 includes an available balance field 852, pending charge fields 854, 856 and 858, and completed or cleared charge fields 860, 862 for review by the cardholder. Adjacent each field 854, 856, 858, 860 and 862 is the available account balance reflecting each of the charges shown. Descriptions are shown for each charge including a transaction date and the name of the merchant.

The pending charges are seen in FIG. 8 with a status of “Processing”, and respective “Dispute” buttons are provided adjacent to each of the pending charges. As such, the system in this example allows the cardholder to identify any of the pending charges as a possible rogue authorization charge that the cardholder may dispute. Considering the example transactions shown in FIG. 8, the cardholder can see that there is a pending transaction and a completed transaction shown from the same merchant (Barcelo Hotel). The completed Barcelo Hotel transaction is shown with a transaction date of Mar. 17, 2017 and amount of $1900.00 in field 862, while the pending transaction is shown with an earlier transaction date of Mar. 15, 2017 and in the amount of $2625.00 in field 858.

Considering the discussion above, the earlier but still pending transaction is probably an advance authorization request made by Barcelo Hotel that is now a rogue authorization charge in view of the later transaction that has been completed. In contrast, the other pending charges shown in fields 854 and 856 are likely not rogue authorization charges based on the merchants involved and/or the absence of another completed transaction by each respective one of the merchants. The earlier but still pending transaction of Barcelo Hotel in the amount of $2625.00 represents about 50% of the total charges in this example and has a significant impact on the available credit balance.

The cardholder, whether or not knowing that Barcelo Hotel likely made an advance authorization charge request that correlates to the pending charge, may select the Dispute button 868. Selection of the Dispute Button 868 is taken as identification to the system of a possible rogue authorization charge in the field 858 that the cardholder wishes to have removed. The other Depute buttons 864, 866 may also be selected if desired. Any selection of the dispute buttons may be accepted by the system as an identification of a possible rouge authorization charge to be addressed by the system.

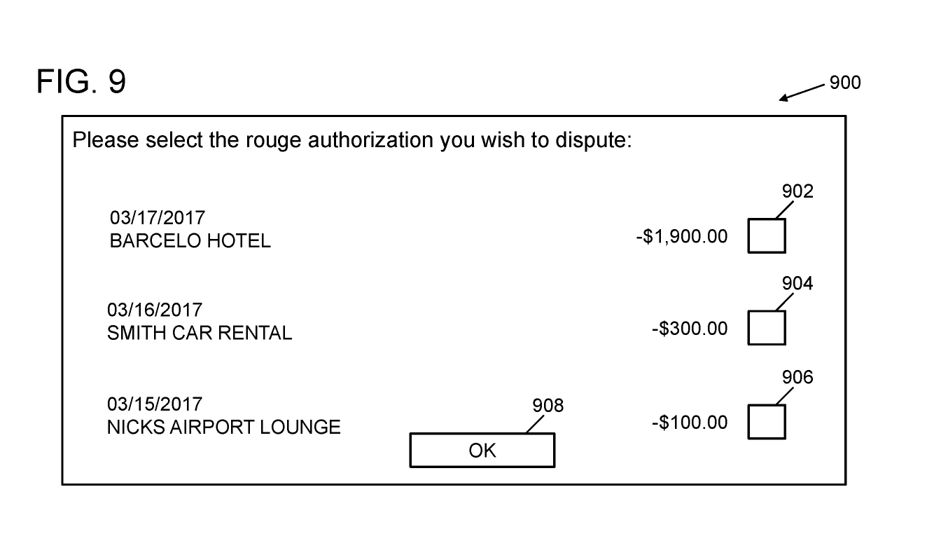

FIG. 9 illustrates a second exemplary display screen 900 for the system shown in FIGS. 1-5. The display screen 900 is presented in response to the selection of the Dispute Button 868 in FIG. 8. The display screen 900 includes cleared charges and respective selection boxes 902, 904, 906 that the cardholder may select to validate the disputed charge identified in the screen 850 of FIG. 8. Following the example of FIG. 8, it is seen from FIG. 9 that the cleared charge for Barcelo Hotel is included amongst other cleared charges. Since Barcelo Hotel is the same merchant for the Disputed Charge, the cardholder may select the box 902 corresponding to the cleared Barcelo Hotel charge. By doing so, the cardholder identifies a cleared charge for the system to use in investigating the disputed charge. The user may proceed by selecting the OK button 908.

The system may compare transaction data for the disputed charge and transaction data for the validation charges involve the same merchant. Since the transaction data for includes merchant identifiers in each of the disputed charge and the validation charge, the system can easily confirm that the merchants for the charges identified in FIGS. 8 and 9 are the same, the charges are accepted as a possible rogue authorization charge and the system operates as described above.

If the cardholder were to identify a charge on screen 900 that relates to a different merchant than the charge selected for DISPUTE on screen 850, this reflects a user error that would not be accepted. The cardholder would be prompted to make another selection, with possible explanation of why the previous selection was rejected. A suspected rogue charge for a transaction involving one merchant cannot be validated by a cleared charge involving another merchant. The rogue authorization charge scenario can only exist between two charges made by the same merchant, with one of them being cleared and one of them remaining pending.

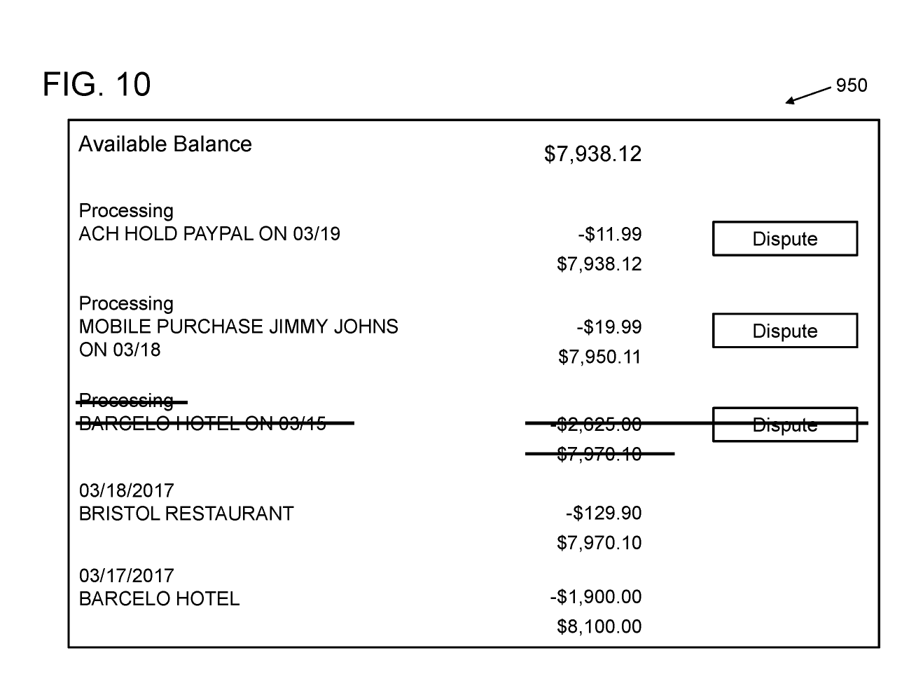

FIG. 10 illustrates a third exemplary display screen 950 for the system shown in FIGS. 1-5. The display screen 950 is responsive to the screen 900 (FIG. 10) discussed above and the selection of the box 902 and the OK button 908. The screen 950 shows the same charges as the screen 850 (FIG. 8) with the disputed Barcelo Hotel charge lined through. While not shown in FIG. 10, a temporary credit has been issued in system in the amount of the disputed charge, and the available balance is accordingly shown in screen 950 as though the disputed charge did not exist. The strikethrough, but not removal, of the disputed charge is an indication that the disputed charge is being investigated. Once the investigation is completed, if the disputed charge is confirmed as a rogue authorization charge the disputed charge may be completely removed from the screen 850 or 950, while the available balance shown in screen 950 is maintained.

The investigation may be completed, and disputed charges either confirmed or rejected as authorized charges by one or more of the system devices 200 or the server system 150 using transaction data and comparisons in an automated manner. The cardholder names, merchant identifiers, transaction dates, identification of goods or services, or other information in the transaction data may be compared to determine if two charges (a pending charge and a cleared charge) of the same merchant present a similar enough match to conclude that the pending charge is actually an advance authorization for charges that were later cleared in the second transaction. If necessary, inquiries can be sent between the financial institutions in the payment system using the respective devices 200 or to the merchant using a device 200 to confirm charges as unprocessed advance authorization for charges.

Secondary considerations such as cardholder or merchant history and length of pendency of charges may also be considered, or may perhaps even be conclusive indicators of rogue charges in an investigation. For example, cardholders that have successfully challenged other charges by the same merchant may be a factor in an investigation, a merchant's history of making advance authorization charges may a factor in an investigation, and charges that are pending for an excessive period of time (beyond a normally expected time for a pending charge to clear) may be a factor in an investigation. Such factors in combination may support a conclusion of a rogue authorization charge apart from any comparison of transaction data as described above. For example, and following the examples described above, system transaction data may indicate that the cardholder frequently travels and stays at Barcelo Hotel, that Barcelo Hotel is known to make advance authorization requests of all of its guests, that similar Barcelo Hotel charges have been successfully challenged by the cardholder and/or other cardholders on previous occasions, and that the disputed Barcelo Hotel charge at issue has been pending for more than ten days total including several days after a cleared Barcelo Hotel charge all present a convincing case that the disputed charge is in all likelihood a rogue charge.

Using primary transaction data comparison, secondary considerations such as those described above, and/or inquiries to the financial institutions and merchants, the identified possible rouge authorization charges can be scored and weighted with confidence intervals for improved accuracy of the system in confirming or rejecting suspected charges. Likewise, the considerations above may be utilized to identify abusive or manipulative users of the system so that corrective measures may be taken.

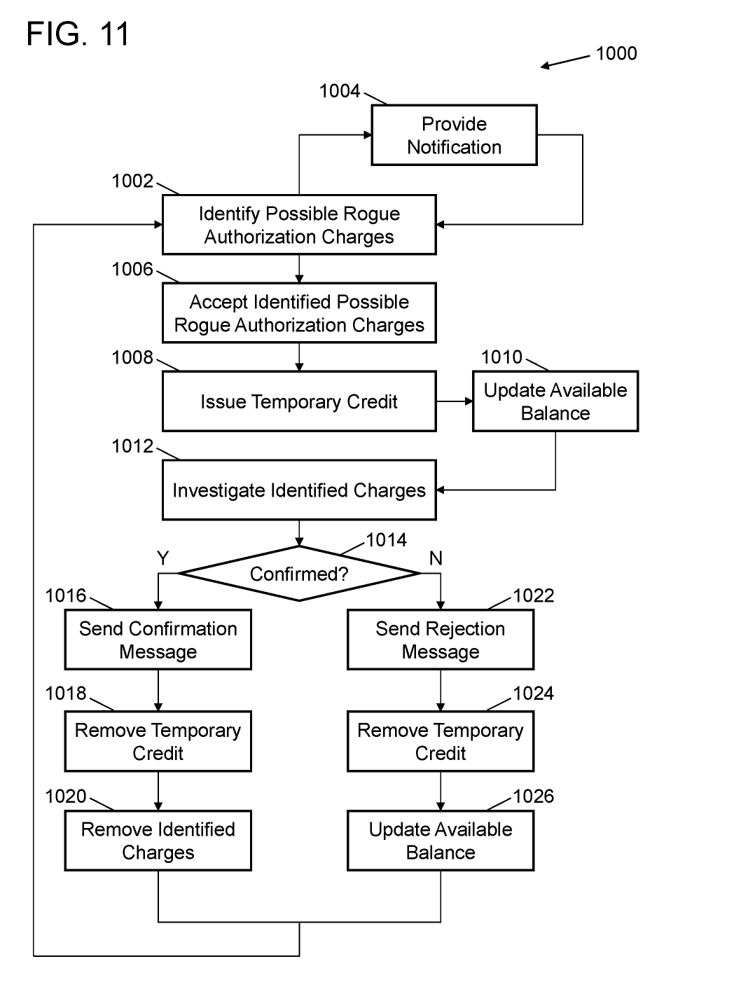

FIG. 11 illustrates an exemplary method flowchart 1000 of processes executed by the system shown in FIGS. 1-5.

At step 1002, at least one device 200 is used to identify a possible rogue authorization charge (or charges) for review by the system. The identification may be made manually by a cardholder as described above in relation to FIGS. 6-10 or by another party using a device 200 communicating with the system. In some cases, the issuer or acquirer financial institution may review pending charges to identify possible rogue authorization charges. The identification of possible rogue authorization charges may also be made by the server system in some cases, or by another device 200 in the system, in an automated manner.

In the case of automated identification, the server 150 or a device 200 can be configured to electronically look for two charges by the same merchant, one pending and one cleared within a certain timeframe. An alert message or notification may optionally be sent to a cardholder or another system user at step 1004 that a possible rogue authorization charge has been identified and asking whether further review is desired. As such, the system in some embodiments does not necessarily rely on a cardholder/user to spot a possible rogue authorization charge in the first instance. The system may actively generate push notifications to cardholders causing a cardholder device to activate and present information to the cardholder concerning possible rogue authorization charges and/or the system may passively provide alerts only when the cardholder logs onto the system or otherwise accesses a cardholder portal to view account information. The system may also generate push notifications to the issuing institution as a way to provide a proactive resolution to the rogue authorization, if that is a service that the issuers chooses. Regardless, the alerts or notifications may provide options for the cardholder and/or the issuer to confirm whether or not the identified charges are considered disputed charges for the system to further act upon.

Once identified per step 1002, the identified possible rogue authorization charges are received or otherwise accepted at step 1006. The device used to identify the possible rogue authorization charges at step 1002 is not necessarily the same device that accepts the identified charges at step 1006, although in some cases these steps may be performed by the same device. The acceptance of the possible rogue authorization charges at step 1006 may involve, as described above, steps of selecting or otherwise identifying another cleared transaction to compare and validate the possible rogue authorization charges

At step 1008, a temporary credit is automatically issued through the payment system and posted to the cardholder account in the amount of the accepted identified possible rogue authorization charge. As described above, the credit may be issued by the device 200 of the issuer of the payment card, although the credit may instead be issued by another financial institution or authorized entity in the payment system. Screens such as those described above may be presented to show the updated available credit balance and status of the accepted identified possible rogue authorization charge while the system completes its assessment. The temporary credit issued by the system cancels the accepted identified possible rogue authorization charge, and the available credit balance is updated at step 1010 to reflect the credit issued. Hardship imposed on the cardholder to further use the card is therefore eliminated.

As shown at step 1012, the accepted identified possible rogue authorization charge is also investigated. The investigation may include any of the techniques described above or otherwise known in the art, and may be conducted by one or more of the devices described in the system. The goal of the investigation is to confirm whether or not the accepted identified possible rogue authorization charge is, in fact, a rogue authorization charge.

As shown at step 1014, if the accepted identified possible rogue authorization charge is confirmed as a rogue authorization charge, a confirmation message is sent at step 1016 to the server that stores the decision and related data. At step 1018 the temporary credit is removed from the cardholder account, and at step 1020 the confirmed rogue authorization charge is also removed. The system then returns and awaits another possible rogue authorization charge to be identified.

As shown at step 1014, if the accepted identified possible rogue authorization charge is not confirmed as a rogue authorization charge, a rejection message is sent at step 1022 to the server that stores the decision and related data. At step 1024 the temporary credit is removed from the cardholder account, and at step 1026 the available account balance is updated to reflect the removal of the credit. The system then returns and awaits another possible rogue authorization charge to be identified.

As will be appreciated based on the foregoing specification, the above-described embodiments of the disclosure may be implemented using computer programming or engineering techniques including computer software, firmware, hardware or any combination or subset thereof, wherein the technical effects described above are achieved. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electronic payment card system comprising:
at least one host computing device comprising at least one processor in communication with a memory device and a payment network for processing payment-by-card transactions,
wherein the at least one host computing device is configured to:
receive an identified possible rogue authorization charge in at least one cardholder account; and
in response to the receiving the identified possible rogue authorization charge, automatically issue a temporary credit through the payment network to the at least one cardholder account in the amount of the received identified possible rogue authorization charge.

2. The system of claim 1, wherein the received identified possible rogue authorization charge is communicated from a cardholder computing device to the at least one host computing device via a cardholder portal.

3. The system of claim 1, wherein the at least one host computing device is a financial institution computing device.

4. The system of claim 3, wherein the financial institution computing device is a card issuer device.

5. The system of claim 1, wherein the at least one host computing device is further configured to confirm whether or not the received identified possible rogue authorization charge is actually a rouge authorization charge.

6. The system of claim 5, wherein the at least one host computing device is configured to:
electronically compare transaction data of the received identified possible rogue authorization charge to transaction data of another recently cleared transaction involving the same merchant; and
if the compared transaction data matches, confirm the accepted identified rogue authorization charge as actually a rouge authorization charge.

7. The system of claim 1, wherein if the accepted identified possible rogue authorization charge is confirmed to actually be a rouge authorization charge, the at least one computing device is further configured to automatically remove the temporary credit and the rogue authorization charge from the at least one cardholder account.

8. The system of claim 1, further comprising a computing device generating at least one screen display allowing a user to identify a possible rogue authorization charge to the at least one computing device.

9. The system of claim 1, further comprising a computing device generating at least one screen display allowing a user to identify a cleared charge for evaluating the identified possible rouge authorization charge.

10. The system of claim 1, further comprising a device generating at least one screen display including a corrected available balance for a confirmed rogue authorization charge.

11. The system of claim 1, wherein the at least one host computing device comprises a server system.

12. The system of claim 1, wherein the at least one host computing device is further configured to:
identify at least one possible rogue authorization charge posted to the at least one cardholder account;
notify the cardholder of the possible rogue authorization charge; and
in response to the notification, allow the cardholder to dispute the possible rogue authorization charge.

13. The system of claim 1, wherein the at least one host computing device is further configured to:
automatically identify at least one possible rogue authorization charge posted to the at least one cardholder account;
alert a card issuer of the possible rogue authorization charge; and
in response to the alert, allow the card issuer to correct the possible rogue authorization charge before any action needs to be taken by the cardholder.

14. A method for correcting rogue authorization charges in an electronic payment card system, the method implemented with at least one host computing device including at least one processor in communication with a memory device and a payment network for processing process payment-by-card transactions, the method comprising:
receiving an identified possible rogue authorization charge in at least one cardholder account; and
in response to the accepted identified possible rogue authorization charge, automatically issuing a temporary credit though the payment network to the at least one cardholder account in the amount of the received identified possible rogue authorization charge.

15. The method of claim 14, wherein receiving the identified possible rogue authorization charge comprises accepting the identified possible authorization charge from a cardholder computing device via a cardholder portal.

16. The method of claim 14, wherein automatically issuing a temporary credit to the at least one cardholder account in the amount of the accepted identified possible rogue authorization charge comprises automatically issuing the temporary credit from a financial institution computing device communicating in the interchange network.

17. The method of claim 14, wherein issuing the temporary credit from a financial institution computing device communicating in the interchange network comprises issuing the temporary credit from a card issuer device.

18. The method of claim 14, further comprising electronically confirming whether or not the accepted identified possible rogue authorization charge is actually a rouge authorization charge.

19. The method of claim 18, wherein electronically confirming whether or not the accepted identified possible rogue authorization charge is actually a rouge authorization charge comprises:
comparing transaction data of the accepted identified possible rogue authorization charge to transaction data of another recently cleared transaction involving the same merchant; and
if the compared transaction data matches, confirming the accepted identified rogue authorization charge as actually a rouge authorization charge.

20. The method of claim 14, further comprising:
if the accepted identified possible rogue authorization charge is confirmed to actually be a rouge authorization charge, automatically removing the temporary credit and the rogue authorization charge from the at least one cardholder account.

21. The method of claim 14, further comprising generating at least one screen display allowing a user to identify the possible rogue authorization charge.

22. The method of claim 14, further comprising generating at least one screen display allowing a user to identify a cleared charge for evaluating the identified possible rouge authorization charge.

23. The method of claim 14, further comprising generating at least one screen display including a corrected available balance for a confirmed rogue authorization charge.

24. The method of claim 14, wherein receiving an identified possible rogue authorization charge in at least one cardholder account comprises accepting an identified possible rogue authorization charge with a server system.

25. The method of claim 14, further comprising:
automatically identifying at least one possible rogue authorization charge posted to the at least one cardholder account;
notifying the cardholder of the possible rogue authorization charge; and
in response to the notification, allowing the cardholder to dispute the possible rogue authorization charge.

26. The method of claim 14, further comprising:
automatically identifying at least one possible rogue authorization charge posted to the at least one cardholder account;
alerting a card issuer of the possible rogue authorization charge; and
in response to the alert, allowing the card issuer to correct the possible rogue authorization charge before any action needs to be taken by the cardholder.
